(19) United States
(12) Patent Application Publication
(10) Pub. No.: US 2009/0264155 A1
(43) Pub. Date: Oct. 22, 2009

(54) BASE STATION WITH A SECURITY SENSOR

(75) Inventors: Shusuke NAKAYAMA, Yokohama-shi (JP); Ryuta FUJISAWA, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/408,626

(22) Filed: Mar. 20, 2009

(30) Foreign Application Priority Data
Mar. 21, 2008 (JP) 2008-074075

(51) Int. Cl. H04B 1/38

(52) U.S. Cl. 455/561

(57) ABSTRACT

Provided is a security technique using a mobile phone terminal and a compact base station that reduce the disadvantages when the mobile phone terminal is left in the house or office or is left without being carried. A base station of a mobile communication system includes a radio unit that wirelessly communicates with a mobile station through wireless communication, a communication unit that communicates with the mobile communication system through a communication line, and a control unit that determines whether there is a location-registered mobile station when a predetermined condition is satisfied and controls the communication unit to transmit a predetermined message to a predetermined counterpart through the communication line when there is no location-registered mobile station.

### CROSS-REFERENCE TO RELATED APPLICATIONS

The present application is based upon and claims the benefit of priority from the prior Japanese Patent Application No. 2008-074075 (filed on Mar. 21, 2008); the entire contents of which are incorporated herein by reference.

### FIELD OF THE INVENTION

The present disclosure relates to a base station of a mobile communication system.

### BACKGROUND

An example of an apparatus developed to cover areas, which are out of service as radio waves from a normal existing base station (or a wide-area base station) cannot be received or in which the communication is unstable due to weak radio waves, includes a compact base station with low output power that provides a small cell (service area) with a radius of about several meters to several dozen meters. Such an ultra-small cell itself or a compact base station that provides the cell will be called a femtocell. However, the ultra-small femtocell is in the category of base stations. Therefore, there are regulations for notification of installation site, permission, operation hours, and so forth by various related laws, and the femtocell is not currently on the market in Japan.

Meanwhile, as the always-on connection of broadband lines such as optical lines, ADSL, and cable phone lines are widely used in the general household, an environment (or backbone) for connecting a femtocell and a mobile communication system is being developed. Furthermore, it is also advantageous for the carriers that the band of a normal existing base station does not have to be used, which would be otherwise used, if the femtocells and the broadband lines are used. Therefore, the full-fledged development and use of the femtocells are expected in the near future after deregulations of the related laws and changes in operations.

An example of a security system includes a system that notifies the security control center when the door or the window is opened/closed when the security apparatus is in operation (a conventional technique). Another example is a conventional technique that finds out position information of a portable terminal from a GPS (Global Positioning System) or a mobile network to determine whether the portable terminal is in a predetermined range and that transmits an abnormality notification if the portable terminal is out of the range (see Japanese Patent Laid-Open No. 2002-352363, paragraphs 0005 to 0007, FIG. 1).

One conventional technique requires the setting by some kind of manpower to activate the system. For example, this conventional technique is useless if the user forgets to set the security apparatus before going out. Furthermore, the system is activated if the user forgets to deactivate the security apparatus when the user comes home, and a wrong alarm is notified to the security company or police. Therefore, the conventional technique could not automatically set the warning state and was completely useless if the user forgets to activate or deactivate the apparatus. The conventional technique also required installation of various expensive sensors (such as infrared ray sensor, camera, and vibration sensor) in the house.

Another conventional technique cannot recognize whether the portable terminal is in a predetermined range and does not properly function if the position information of the portable terminal cannot be acquired when the portable terminal is in a place, such as in a building or underground, where a GPS signal cannot be received or in a place out of mobile network service. Even if the position is estimated from the last position information, there would be a deviation from the actual position. Therefore, there is a problem that a warning message may not be sent when needed or may be sent when not needed. Furthermore, there is also a problem that the portable terminal would have to be fixed in advance, and it is difficult to apply the technique to many unspecified terminals.

Although being small in size, the femtocell is still a base station and includes communication functions such as a reception function and a transmission function. However, the communication functions are intended for communications of mobile phones only, and the use in other applications is not considered.

An object of the present invention is to provide a technique and system for establishing an inexpensive security system using a femtocell, which is expected to be marketed and diffused in the future, as a security sensor.

### SUMMARY

The presently disclosed embodiments are directed to solving issues relating to one or more of the problems presented in the prior art, as well as providing additional features that will become readily apparent by reference to the following detailed description when taken in conjunction with the accompanying drawings.

One aspect of the present disclosure provides a base station of a mobile communication system, the base station including a radio unit that wirelessly communicates with a mobile station by wireless communication; a communication unit that communicates with a mobile communication system through a communication line; and a control unit that determines whether there is a mobile station location-registered in the base station when a predetermined condition is satisfied (after monitoring whether the predetermined condition is satisfied) and controls the communication unit to transmit a predetermined message to a predetermined counterpart through the communication line when there is no mobile station location-registered in the base station.

Another embodiment is directed to a base station of a mobile communication system, the base station including a registering unit that registers information of mobile stations that use the base station, wherein the control unit determines whether there is at least one mobile station, among the mobile stations location-registered in the base station, that is registered in the registering unit and controls the communication unit to transmit a predetermined massage to a predetermined counterpart through the communication line when there is no mobile station registered in the registering unit.

Yet another embodiment is directed to a base station of a mobile communication system, the base station including a registering unit that registers information of mobile stations that use the base station, wherein a control unit determines whether there is at least one mobile station registered in a registering unit and whether there is at least one mobile station not registered in a registering unit among the plurality of mobile stations location-registered in the base station and controls a communication unit to transmit a predetermined message to at least one mobile station location-registered in the base station and registered in the registering unit through the communication line when there is at least one mobile station registered in a registering unit and there is at least one mobile station not registered in the registering unit.

Yet another embodiment is directed to a base station of a mobile communication system, wherein a control unit controls the communication unit to transmit a predetermined message to a predetermined counterpart through the communication line when there is no response from at least one mobile station determined to be location-registered in the base station and registered in a registering unit and to which the predetermined message is transmitted.

According to one specific embodiment, the predetermined counterpart is a mobile station not currently location-registered in the base station among the mobile stations registered in the registering unit.

Yet another embodiment is directed to a base station of a mobile communication system, wherein the base station is installed in a construction (e.g., a house, office in a building, room, and the like), the base station acquires an opened state of a fixture (e.g., door, window, and the like) installed in an opening (e.g., a door frame, a window frame, and the like) of the construction, and a control unit determines that a predetermined condition is satisfied when the opened state of the fixture is acquired.

Although a solving means for the present disclosure has been described as an apparatus, it should be understood that the present disclosure can also be realized by a method, a program, and a storage medium recording the program that are substantially equivalent to the means, and these are also included in the scope of the present disclosure. An arithmetic processor, such as a CPU and a DSP, is used to process data as necessary in the steps of the method and program described below. Inputted data as well as processed and generated data are stored in a storage device such as an HDD and a memory.

According to the present disclosure, a mobile phone terminal and a compact base station can be used to inexpensively and easily guard a general household or a small office and to detect and report the existence of a suspicious individual and the like.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following Figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a block diagram of the entire network using a femtocell (e.g., a compact base station) according to an embodiment of the present disclosure;

FIG. 2 is a block diagram of the femtocell shown in FIG. 1, according to an embodiment;

FIG. 3 is a flow chart showing a process of the femtocell according to an embodiment; and

FIG. 4 is a flow chart showing a process of the femtocell according to an embodiment.

### DETAILED DESCRIPTION OF VARIOUS EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

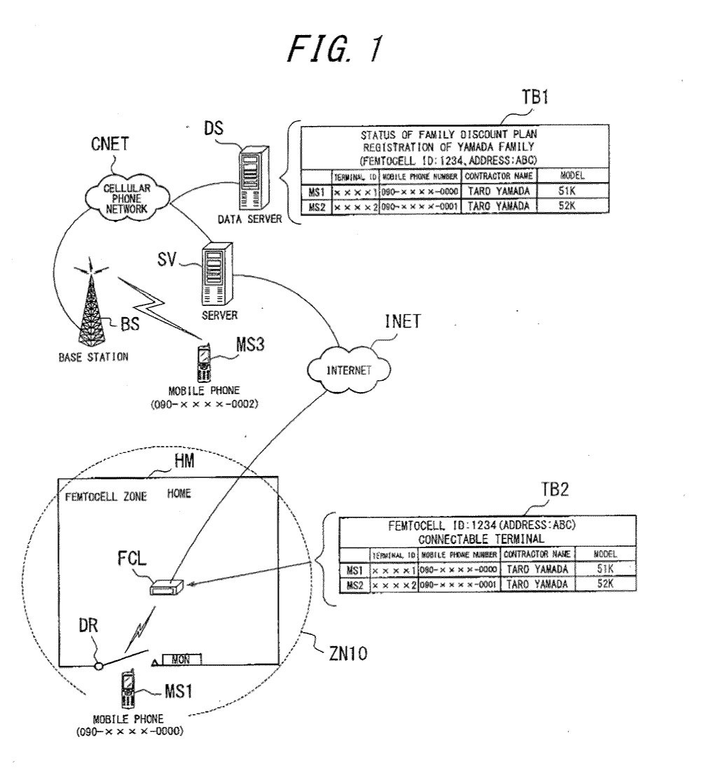

FIG. 1 is a block diagram of the entire network using a femtocell (compact base station of a mobile communication system) according to an embodiment of the present invention. As shown in FIG. 1, a femtocell FCL is installed at home HM and forms a femtocell zone (area) ZN10 that extends outside the outer wall. The area covered by the femtocell FCL for warning is significantly small and often has about the size of a house of general household or a small office. Therefore, it is advantageous to set the area of the femtocell FCL as a warning area, because the area can be limited to the house and the proximity of the house. When the outer wall is made of material such as concrete, in which a radio wave is hard to pass through, or the permeability of the radio wave in use is low, the femtocell zone (area) is formed along the outer wall in some cases. Such a case is more advantageous because only inside the home HM can be set as an area for security detection.

The femtocell zone ZN10 formed in the present configuration extends outside the outer wall. Therefore, the femtocell zone ZN10 outside the home HM may falsely detect a mobile phone of a third party passing by. To prevent the false detection, an open/close monitor MON that detects open/close of a fixture, such as a door DR, installed in a construction is installed on the door DR, on the opening on which the door is installed, or on the proximity of the opening. The open/close monitor MON transmits a signal indicating “OPEN” to the femtocell through wireless/wired transmission when the door DR is in an opened state. The femtocell FCL is configured to activate a security function only when the signal indicating “OPEN” is received from the open/close monitor MON. According to such a configuration, the information of the open/close monitor MON installed on the opening can be used to prevent the false detection caused by a mobile phone carried by a third party passing by.

If a mobile phone is in the femtocell zone ZN10, the mobile phone can communicate with the femtocell FCL. The femtocell FCL is connected to a cellular phone network CNET via the Internet INET and a server SV for cellular phone network connection authentication through a broadband line, such as ADSL (Asymmetric Digital Subscriber Line) and optical fibers, installed in the general household. Conventional public base stations BS1 and BS2 and a data server DS that stores user information such as the status of family discount plan registration are connected to the cellular phone network CNET. A table TB1 including the data on the data server DS is changed when the user information is changed. A mobile phone MS3 is wirelessly connected to the conventional base stations BS1 and BS2. When a mobile phone (which is a mobile station, in a broad sense) MS1 positioned outside the femtocell zone ZN10 of the femtocell FCL enters the femtocell zone ZN10, the mobile phone MS1 can start wireless connection after the location is registered in the femtocell FCL.

The femtocell FCL operates in the same way as a normal macrocell base station (public base station) and is capable of registering the locations of surrounding “mobile phones” of other people as well to the femtocell FCL. Therefore, a memory area (storage unit) in the femtocell FCL includes an area for storing connectable terminals (group-registered terminals) registered in the femtocell in advance, and information of a table TB2 of FIG. 1 is retained in the area. Information, such as mobile phone numbers of predetermined counterparts, fixed-line phone numbers, and e-mail addresses, content of a warning message “intruder detected”, and the like are stored in the storage unit in advance.

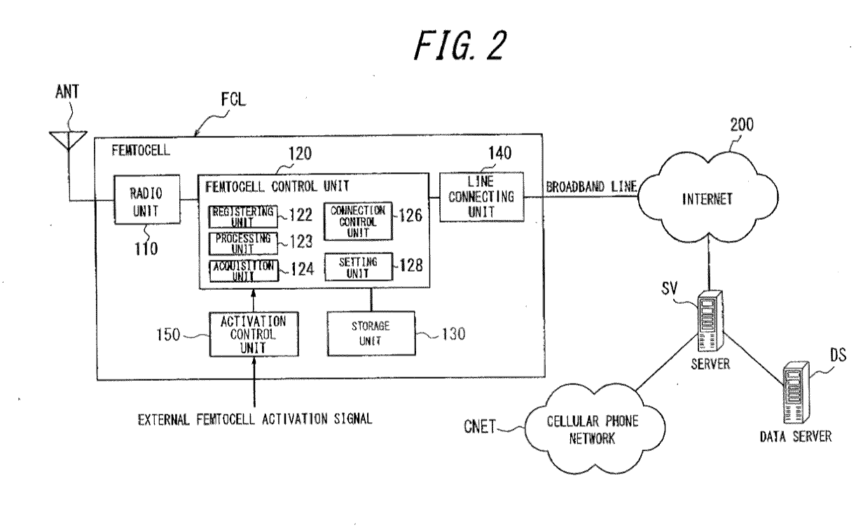

FIG. 2 is a block diagram of the femtocell shown in FIG. 1. As shown in FIG. 1, the femtocell FCL comprises a radio unit 110 for wireless communication with a mobile phone terminal (mobile station), a femtocell control unit 120 that controls the entire apparatus, a storage unit 130 that stores various setting information, a line connecting unit (communication unit) 140 that connects to a broadband line such as the Internet or the like to communicate with a mobile communication system (such as cellular phone network CNET, or base stations and mobile phones connected to the cellular phone network CNET), an activation control unit (acquisition unit) 150 that acquires an external activation signal (for example, a signal indicating an opened state of the door) to change the femtocell from a sleep state (or dormant state) to a normal state with the signal as a trigger, and an antenna ANT that transmits and receives radio waves to communicate with the mobile phone terminals. The femtocell control unit 120 includes, according to one embodiment, a registering unit 122 that registers information of the user of at least one mobile station (user contract information) using the femtocell FCL; a processing unit 123 that processes location-registration and the like of the mobile station and that monitors door opening information to cause the femtocell to function as a security apparatus; an acquisition unit 124 that acquires usage contract information of the mobile station, which the user has made a contract with the provider of the mobile communication system, from the server of the provider based on information such as information of the user registered in the registering unit 122 and information specific to the femtocell; a connection control unit 126 that controls wireless connection of the mobile station to the femtocell FCL based on the usage contract information; and a setting unit 128 that sets and deactivates a warning mode.

The registering unit 122 registers information (identification information such as a mobile phone number and a terminal ID) of the user of at least one mobile station using the femtocell FCL through a wireless or broadband line. The registered information is also stored in the storage unit 130.

The processing unit 123 determines whether there is a mobile station location-registered in the base station when a predetermined condition is satisfied and controls the line connecting unit 140 to transmit a predetermined message to a predetermined counterpart through a communication line when there is no mobile station location-registered in the base station. The activation control unit 150 acquires an opened state of a fixture (for example, door) installed on an opening of a construction, and the processing unit 123 determines that the predetermined condition is satisfied when the activation control unit 150 acquires the opened state of the fixture.

Alternatively, the processing unit 123 determines whether there is at least one mobile station registered in the registering unit 122 among the mobile stations location-registered in the base station and controls the line connecting unit 140 to transmit a predetermined message to a predetermined counterpart through the communication line when there is no mobile station registered in the registering unit 122.

Furthermore, the processing unit 123 determines whether there is at least one mobile station registered in the registering unit 122 and whether there is at least one mobile station not registered in the registering unit 122 among the plurality of mobile stations location-registered in the base station and controls the line connecting unit 140 to transmit a predetermined message to at least one mobile station determined to be location-registered in the base station and registered in the registering unit 122 through the communication line when there is at least one mobile station registered in the registering unit 122 and there is at least one mobile station not registered in the registering unit 122. Alternatively, the processing unit 123 controls the radio unit 110 to transmit the predetermined message through wireless communication.

Preferably, the processing unit 123 controls the line connecting unit 140 to transmit a predetermined message to a predetermined counterpart through the communication line when there is no response from the at least one mobile station determined to be location-registered in the base station and registered in the registering unit 122 and to which the predetermined message is transmitted.

When the user purchases a new femtocell and sets the femtocell at home, it is preferable that the femtocell can be used by a plurality of mobile phones in the name of the user. However, if anyone can use the femtocell, the user may not be able to access the femtocell with the user's mobile phones even though the user uses a broadband line contracted by the user and further pays electric and other bills, because of the limitation in the number of terminals connectable to the femtocell or the band limitation. Furthermore, if the user privately purchases the femtocell, the operation of registering the persons who can use the femtocell is complicated and cumbersome. To prevent such a complicated setup operation, the femtocell FCL can, for example, download the table TB1 including the status of family plan registration retained by the provider of the mobile phone from the data server DS through the network as shown in FIG. 1 and retain the table TB1 in the storage unit of the femtocell FCL as the table TB2.

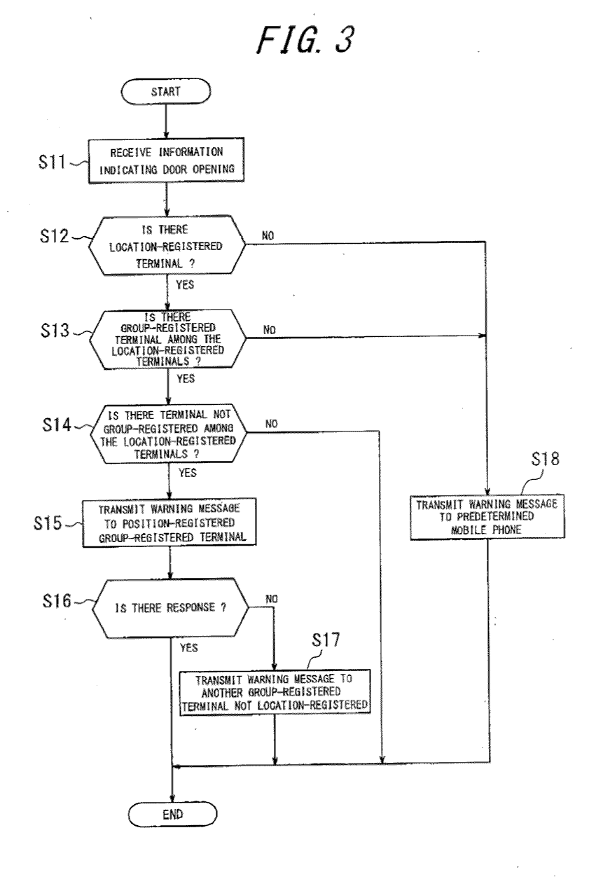

FIG. 3 is a flow chart showing a process of the femtocell according one embodiment. As shown in FIG. 3, the femtocell FCL receives information indicating opening of the door DR from the open/close monitor MON in step S11. In step S12, the femtocell FCL determines whether there is a location-registered terminal. If there is no location-registered terminal, the femtocell FCL transmits a warning message (such as “The door is open, intruder detected.”) to a predetermined mobile phone (predetermined counterpart) in step S18 and ends the process. If it is determined that there is a location-registered terminal, the femtocell FCL determines whether there is a group-registered (thus, connection to the femtocell FCL is permitted by registration to the table TB2) terminal among the location-registered terminals in step S13.

If there is no group-registered terminal, the femtocell FCL executes step S18 and ends the process. If it is determined that there is a group-registered terminal, the femtocell FCL determines whether there is a terminal not group-registered among the location-registered terminals in step S14. If there is no terminal that is not group-registered, the process ends. If it is determined that there is a terminal not group-registered, the femtocell FCL transmits a warning message (such as “The door is open, security is activated. Respond immediately.” to the group-registered terminal that is location-registered in step S15. In step S16, the femtocell FCL determines whether there is a response (some kind of wireless signal transmitted by manual operation) from the group-registered terminal. Whether there is a response is monitored for a predetermined period (for example, one, two, or five minutes), and the femtocell FCL determines that there is no response if there is no response within the predetermined period.

The existence of the response indicates that there is a user carrying the terminal in the house. Therefore, it is regarded as “no problem”, and the process ends. If there is no response, it is likely that the user left the terminal in the house or went out without carrying the terminal. Therefore, if there is no response, the femtocell FCL transmits a warning message to another group-registered terminal that is not currently location-registered in step S17 and ends the process. The warning message in this case is, for example, “The door is open, there is an intruder. There is a left terminal 090-xxxx-xxxx at home”. The femtocell FCL has acquired information of the terminal ID (or, for example, phone number as an identifier of the terminal and so forth) of the registered terminal. Therefore, the warning message may be, for example, “The door is open, there is an intruder, terminal ID of the intruder is xxxx9. There is a left terminal 090-xxxx-xxxx at home.”

In step S17, the femtocell FCL may transmit the warning message not only to another group-registered terminal that is not location-registered, but also to another predetermined counterpart (such as mobile phone, fixed-line phone, and PC) stored in the storage unit 130 of the femtocell FCL. The text data, the audio data, and the like of the warning messages described above are stored in the storage unit 130 in advance. Alternatively, the femtocell control unit (CPU) 120 may electronically synthesize the sound of the warning messages. The process of step S11 may be omitted if the wireless zone formed by the femtocell FCL is substantially within the construction (house). In that case, the detection of location registration by the mobile station satisfies the predetermined condition. Step S12 is also omitted. The process of step S14 may be omitted, and all messages may be transmitted when the opening of the door is detected.

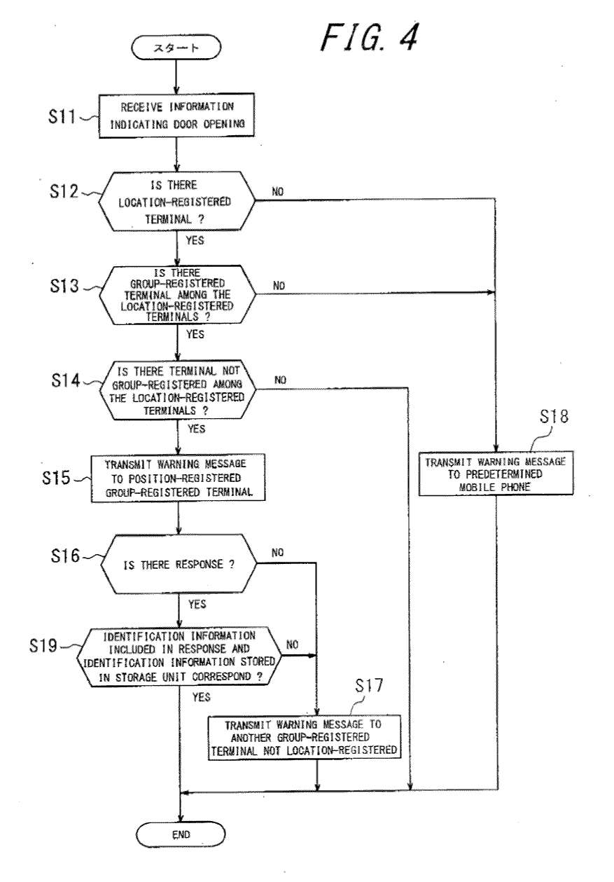

In the present embodiment, the femtocell FCL can be used to accurately detect the intruder and transmit a warning message to a predetermined counterpart even if the user has left the mobile phone in the house or left the mobile phone behind (in other words, state that the user “forgot to lock”) or if a user who is not the owner of the group-registered terminal brings in the mobile phone. However, the intruder may notice the “left mobile phone” and “impersonate as the user” to transmit a response message to the femtocell FCL. The present embodiment cannot deal with such “impersonation”. Thus, one embodiment including a process of preventing the “impersonation” by a third party such as an intruder will be described with reference to FIG. 4.

FIG. 4 is a flow chart showing a process of the femtocell according to one embodiment. Steps S11 to S18 are similar to steps described above. After receiving the warning message of Step S15, the mobile phone prompts the user to input predetermined identification information to an input unit (such as a microphone and a key operation unit) by a display unit, a sound output unit, or the like. For example, the display unit displays “Input password as personally identifying information” or “Input biometric information as personally identifying information”. Examples of the biometric information include fingerprint authentication data and vein authentication data. Therefore, when the input of biometric information is requested, the mobile phone comprises some kind of a biological authentication apparatus (such as a fingerprint authentication apparatus, a vein authentication apparatus, and a voiceprint authentication apparatus).

The user (owner or a third party such as an intruder) who carries the mobile phone uses a key operation unit, a microphone, or a biological authentication information detector to input “personally identifying information” such as biometric information and password to the mobile phone. After receiving the input, the mobile phone returns a response to the femtocell FCL. After receiving the response, the femtocell FCL determines that there is a response in step S16 and proceeds to step S19. As shown in FIG. 4, in step S19, the femtocell FCL determines whether the personally identifying information included in the response and the personally identifying information stored in the storage unit 130 of the femtocell FCL in advance correspond. If the pieces of the personally identifying information do not correspond, the femtocell FCL regards it as an unauthorized “impersonation” by a third party and transmits a warning message to another group-registered terminal not currently location-registered and to a predetermined counterpart in step S17. The warning message in this case can be, for example, “Door is opened, there is an intruder. The intruder impersonates as the user of terminal 090-xxxx-xxxx”.

Although the present invention has been described based on the drawings and the embodiments, it should be noted that those skilled in the art can easily make modifications and corrections in various ways based on the present disclosure. Therefore, it should be understood that the modifications and the corrections are included in the scope of the present invention. For example, the functions and the like included in the components, steps, and the like can be rearranged without being logically inconsistent and can be combined into one or divided into a plurality of means or steps.

What is claimed is:

1. A base station of a mobile communication system, the base station comprising:
a radio unit that wirelessly communicates with a mobile station by wireless communication;
a communication unit that communicates with the mobile communication system through a communication line; and
a control unit that determines whether there is a mobile station location-registered in the base station when a predetermined condition is satisfied and controls the communication unit to transmit a predetermined message to a predetermined counterpart through the communication line when there is no mobile station location-registered in the base station.

2. The base station according to claim 1, further comprising
a registering unit that registers information of one or more mobile stations that use the base station, wherein
the control unit determines whether there is at least one mobile station, among the one or more mobile stations location-registered in the base station, that is registered in the registering unit and controls the communication unit to transmit a predetermined massage to a predetermined counterpart through the communication line when there is no mobile station registered in the registering unit.

3. The base station according to claim 1, further comprising
a registering unit that registers information of one or more mobile stations that use the base station, wherein
the control unit determines whether there is at least one mobile station registered in the registering unit and whether there is at least one mobile station not registered in the registering unit among the one or more mobile stations location-registered in the base station and controls the communication unit to transmit a predetermined message to at least one mobile station location-registered in the base station and registered in the registering unit through the communication line when there is at least one mobile station registered in the registering unit and there is at least one mobile station not registered in the registering unit.

4. The base station according to claim 3, wherein
the control unit controls the communication unit to transmit a predetermined message to a predetermined counterpart through the communication line when there is no response from the at least one mobile station determined to be location-registered in the base station and registered in the registering unit and to which the predetermined message is transmitted.

5. The base station according to claim 1, wherein
the base station is installed in a construction,
the base station acquires an opened state of a fixture installed in an opening of the construction, and
the control unit determines that the predetermined condition is satisfied when the opened state of the fixture is acquired.

6. The base station according to claim 2, wherein
the base station is installed in a construction,
the base station acquires an opened state of a fixture installed in an opening of the construction, and
the control unit determines that the predetermined condition is satisfied when the opened state of the fixture is acquired.

7. The base station according to claim 3, wherein
the base station is installed in a construction,
the base station acquires an opened state of a fixture installed in an opening of the construction, and
the control unit determines that the predetermined condition is satisfied when the opened state of the fixture is acquired.

8. The base station according to claim 4, wherein
the base station is installed in a construction,
the base station acquires an opened state of a fixture installed in an opening of the construction, and
the control unit determines that the predetermined condition is satisfied when the opened state of the fixture is acquired.
